(19) United States
(12) Patent Application Publication
(10) Pub. No.: US 2026/0312771 A1
(43) Pub. Date: Oct. 8, 2026

(54) METHODS AND APPARATUSES FOR HARQ-ACK FEEDBACK GENERATION FOR TCI APPLICATION

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 19/479,046

(22) PCT Filed: Jun. 13, 2024
(86) PCT No.: PCT/CN2024/098905

§ 371 Date: Oct. 27, 2025

(51) Int. Cl. H04L 5/00

(52) U.S. Cl. CPC H04L 5/0055; H04L 5/0044

(57) ABSTRACT

Embodiments of the present disclosure relate to methods and apparatuses for HARQ-ACK feedback generation. A UE may: receive signaling for configuring a first set of serving cells, which is co-schedulable by a DCI; receive the DCI scheduling a second set of serving cells in the first set of serving cells and indicating a TCI state different from a previously indicated TCI state; generate a HARQ-ACK codebook for the DCI; transmit the HARQ-ACK codebook; and apply the TCI state in response to the HARQ-ACK codebook including at least one ACK bit.

### TECHNICAL FIELD

Embodiments of the present disclosure generally relate to wireless communication technology, and more particularly to hybrid automatic repeat request acknowledgement (HARQ-ACK) feedback generation.

### BACKGROUND

A wireless communication system may include one or multiple network communication devices, such as base stations (BS), which may support wireless communication for one or multiple user communication devices, which may be otherwise known as user equipment (UE), or other suitable terminology. The wireless communication system may support wireless communication with one or multiple user communication devices by utilizing resources of the wireless communication system (e.g., time resources (e.g., symbols, slots, subframes, frames, or the like)) or frequency resources (e.g., subcarriers, carriers, or the like). Additionally, the wireless communication system may support wireless communication across various radio access technologies including third generation (3G) radio access technology, fourth generation (4G) radio access technology, fifth generation (5G) (which is also known as new radio (NR)) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some embodiments of the present disclosure provide a UE. The UE may include at least one memory; and at least one processor coupled with the at least one memory and configured to cause the UE to: receive signaling for configuring a first set of serving cells, which is co-schedulable by a downlink control information (DCI); receive the DCI scheduling a second set of serving cells in the first set of serving cells and indicating a transmission configuration indication (TCI) state different from a previously indicated TCI state; generate a hybrid automatic repeat request acknowledgement (HARQ-ACK) codebook for the DCI; transmit the HARQ-ACK codebook; and apply the TCI state in response to the HARQ-ACK codebook including at least one acknowledgement (ACK) bit.

Some embodiments of the present disclosure provide a BS. The BS may include at least one memory; and at least one processor coupled with the at least one memory and configured to cause the BS to: transmit, to a UE, signaling for configuring a first set of serving cells, which is co-schedulable by a DCI; transmit, to the UE, the DCI scheduling a second set of serving cells in the first set of serving cells and indicating a TCI state different from a previously TCI state indicated to the UE; receive, from the UE, a HARQ-ACK codebook for the DCI; and apply the TCI state in response to the HARQ-ACK codebook including at least one ACK bit.

Some embodiments of the present disclosure provide a processor. The processor may include at least one controller coupled with at least one memory and configured to cause the processor to: receive signaling for configuring a first set of serving cells, which is co-schedulable by a DCI; receive the DCI scheduling a second set of serving cells in the first set of serving cells and indicating a TCI state different from a previously indicated TCI state; generate a HARQ-ACK codebook for the DCI; transmit the HARQ-ACK codebook; and apply the TCI state in response to the HARQ-ACK codebook including at least one ACK bit.

Some embodiments of the present disclosure provide a processor. The processor may include at least one controller coupled with at least one memory and configured to cause the processor to: transmit, to a UE, signaling for configuring a first set of serving cells, which is co-schedulable by a DCI; transmit, to the UE, the DCI scheduling a second set of serving cells in the first set of serving cells and indicating a TCI state different from a previously TCI state indicated to the UE; receive, from the UE, a HARQ-ACK codebook for the DCI; and apply the TCI state in response to the HARQ-ACK codebook including at least one ACK bit.

Some embodiments of the present disclosure provide a method for wireless communication. The method may include: receiving signaling for configuring a first set of serving cells, which is co-schedulable by a DCI; receiving the DCI scheduling a second set of serving cells in the first set of serving cells and indicating a TCI state different from a previously indicated TCI state; generating a HARQ-ACK codebook for the DCI; transmitting the HARQ-ACK codebook; and applying the TCI state in response to the HARQ-ACK codebook including at least one ACK bit.

Some embodiments of the present disclosure provide a method for wireless communication. The method may include: transmitting, to a UE, signaling for configuring a first set of serving cells, which is co-schedulable by a DCI; transmitting, to the UE, the DCI scheduling a second set of serving cells in the first set of serving cells and indicating a TCI state different from a previously TCI state indicated to the UE; receiving, from the UE, a HARQ-ACK codebook for the DCI; and applying the TCI state in response to the HARQ-ACK codebook including at least one ACK bit.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate schematic diagrams of HARQ-ACK feedback generation in accordance with some embodiments of the present disclosure;

FIGS. 4 and 5 illustrate flowcharts of wireless communication methods in accordance with some embodiments of the present disclosure;

FIG. 6 illustrates an example of a UE in accordance with some embodiments of the present disclosure;

FIG. 7 illustrates an example of a processor in accordance with some embodiments of the present disclosure; and

FIG. 8 illustrates an example of a network equipment (NE) in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G NR or 6G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

A DCI may indicate a TCI state to a UE. It is expected that the indicated TCI state is applied after a certain time of the reception or transmission of the DCI. It is desired to ensure that the BS and the UE have the same understanding on the TCI update.

The present disclosure provides various methods and apparatuses for generating HARQ-ACK feedback for a multi-cell scheduling DCI such that the BS and the UE have the same understanding on the TCI update.

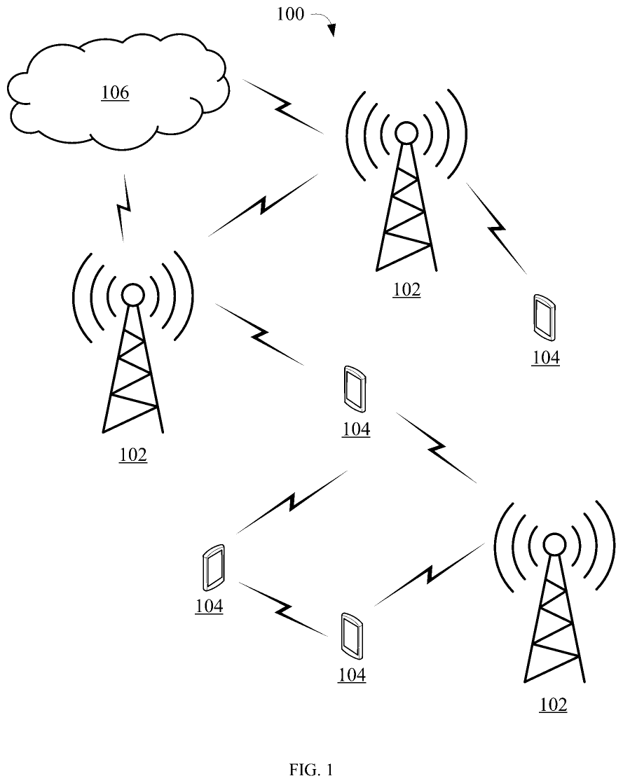

FIG. 1 illustrates a schematic diagram of wireless communication system 100 in accordance with some embodiments of the present disclosure.

The wireless communication system 100 may include one or more NEs 102 (e.g., one or more BSs), one or more UEs 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultra-wideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NEs 102 may be dispersed throughout a geographic region to form the wireless communication system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with a different NE 102.

The one or more UEs 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communication with the CN 106, or with another NE 102, or both. For example, an NE 102 may interface with another NE 102 or the CN 106 through one or more backhaul links (e.g., S1, N2, N3 or another network interface). In some implementations, the NE 102 may communicate with each other directly. In some other implementations, the NE 102 may communicate with each other or indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management (AMF)) functions and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communication). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

In some embodiments, the NEs 102 may include one or more relay nodes, integrated access and backhaul (IAB) nodes or wireless access backhaul (WAB) nodes which can provide wireless access services for UEs 104. A relay node (or an IAB node or a WAB node) can directly connect to a BS or hop through one or more relay nodes (or one or more IAB or WAB nodes) before reaching the BS.

One or more numerologies may be supported in the wireless communication system 100, and a numerology may include a subcarrier spacing and a cyclic prefix. A first numerology (e.g., p=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., p=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A sixth numerology (e.g., μ=5) may be associated with a sixth subcarrier spacing (e.g., 480 kHz) and a normal cyclic prefix. A seventh numerology (e.g., μ=6) may be associated with a seventh subcarrier spacing (e.g., 960 kHz) and a normal cyclic prefix. For ambient IoT communication, additional numerologies (e.g., μ=−1 or μ=−2) may be introduced corresponding to 7.5 kHz or 3.75 kHz respectively.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. By way of example, the wireless communication system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHZ-114.25 GHZ), FR4a or FR4-1 (52.6 GHZ-71 GHz), and FR5 (114.25 GHz-300 GHz). In some implementations, the NEs 102 and the UEs 104 may perform wireless communication over one or more of the operating frequency bands. In some implementations, FRI may be used by the NEs 102 and the UEs 104, among other equipment or devices for cellular communication traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, a UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, a UE 104 includes wearable devices, such as smart watches, fitness bands, optical head-mounted displays, or the like. Moreover, a UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE 104 may communicate with an NE 102 (e.g., a BS) via uplink (UL) communication signals. An NE 102 may communicate with a UE 104 via downlink (DL) communication signals.

In some embodiments of the present disclosure, an NE 102 and a UE 104 may communicate over licensed spectrums, whereas in some other embodiments, an NE 102 and a UE 104 may communicate over unlicensed spectrums. The present disclosure is not intended to be limited to the implementation of any particular wireless communication system architecture or protocol. Persons skilled in the art should understand that as technology develops and advances, the terminologies described in the present disclosure may change, but should not affect or limit the principles and spirit of the present disclosure.

In a wireless communication system, such as the wireless communication system 100, a UE may monitor a PDCCH in one or more search spaces. The PDCCH may carry a DCI, which may schedule an uplink channel, such as a physical uplink shared channel (PUSCH), or a downlink channel, such as a PDSCH, on a cell. In the case that a DCI schedules a PDSCH, the UE may transmit HARQ-ACK feedback (e.g., HARQ-ACK information bit(s)) for the PDSCH through a PUSCH or a PUCCH. For example, the PUCCH may carry a HARQ-ACK codebook including the HARQ-ACK information bit(s) for the PDSCH.

In some embodiments of present disclosure, a DCI may indicate a TCI state to a UE. For example, the DCI may carry a TCI state indication without DL assignment or the DCI may carry a TCI state indication and simultaneously schedule a PDSCH. The indicated TCI state may be different from the previously indicated TCI state. A TCI update is expected to be applied after a certain time of the reception of the DCI. However, under certain circumstances, for example, the UE misses the DCI, the BS and the UE may have a different understanding on the TCI update. That is, the updated TCI state may be applied at the BS side, but not the UE side. To solve this problem, it is proposed that the indicated TCI update is applied when the UE generates an ACK and transmits it in a PUCCH or a PUSCH to the BS.

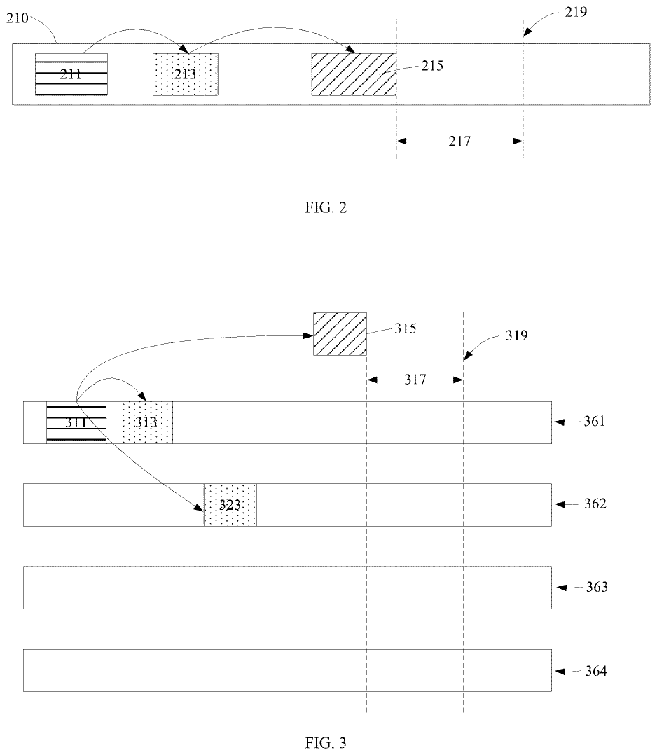

For example, referring to FIG. 2, DCI 211 may schedule PDSCH 213 on cell 210 and indicate a TCI state different from a previously indicated TCI state. Assuming that a UE receives DCI 211 and correctly decodes PDSCH 213, the UE generates an ACK and transmits it in PUCCH 215 to a BS. In some other examples, the HARQ-ACK feedback may be transmitted in a PUSCH. In some other examples, DCI 211 may carry a TCI state indication without DL assignment (e.g., does not schedule PDSCH 213), and the UE may generate an ACK in response to the reception of the DCI or in response to the reception of the TCI state indication.

In response to receiving the ACK, the BS would know that the UE will apply the updated TCI state. For example, a time offset (e.g., “beamAppTime” denoted as 217 in FIG. 2) for applying the updated TCI state may be configured for the UE. The time offset may be relative to the PUCCH or PUSCH carrying the HARQ-ACK feedback. As shown in FIG. 2, the updated TCI state may be applied at 219, for example, starting from the first slot that is at least “beamAppTime” symbols after the last symbol of the PUCCH 215 (or the PUSCH). The first slot and the beamAppTime symbols may be determined on the active bandwidth part (BWP) with the smallest subcarrier spacing (SCS) among the BWPs from the carrier components (CCs) applying the indicated TCI state that are active at the end of the PUCCH or the PUSCH carrying the positive HARQ-ACK.

In some examples, if the UE receives more than one indicated TCI state for a component carrier (CC) or BWP to be applied at the same time (e.g., at 219), the indicated TCI state carried in the latest DCI in time corresponding to positive HARQ-ACK value (e.g., ACK) is applied.

Assuming that the UE misses DCI 211, the UE may generate a negative ACK (NACK) to the BS. The BS would know that the UE does not receive the TCI state indication. In such a scenario, both the BS and the UE do not apply the indicated TCI state at 219. In this way, the BS and the UE have the same understanding on the TCI update.

In some embodiments of the present disclosure, the wireless communication system 100 may be designed to support carrier aggregation (CA). For example, the wireless communication system 100 may support a maximum of 16 component carriers (CCs) in the case of carrier aggregation (CA) or a maximum of 32 CCs in the case of dual connectivity (DC). In some embodiments of the present disclosure, to reduce signaling overhead, it would be beneficial to use a single DCI to schedule multiple PDSCHs or PUSCHs on multiple cells (or carriers). In the context of the present disclosure, the term “cell” may be used interchangeably with the term “carrier.” In the present disclosure, the DCI that can schedule one or more cells is referred to as the multi-cell scheduling DCI.

For example, a set of cells which can include up to M cells (e.g., M=4) can be configured for a UE by a BS via, for example, radio resource control (RRC) signaling. The value of M may be predefined (e.g., in a standard(s)). One DCI can schedule one or more cells within the set of cells for DL transmission with one PDSCH per scheduled cell. In some examples, a DCI may not schedule any cells in the set of cells but indicate certain information (e.g., indicating secondary cell (SCell) dormancy or the like) with respect to at least one cell in the set of cells. In some examples, a DCI may schedule one or more cells in the set of cells and indicate certain information with respect to at least one cell in the set of cells. All these DCIs can be referred to as a multi-cell scheduling DCI, that is, a DCI associated with the configured set of cells for multi-cell scheduling. For convenience, DCI format 1_3 is used in this disclosure as an example of such a DCI.

In some embodiments of the present disclosure, a multi-cell scheduling DCI may indicate a TCI update, for example, indicating a TCI state different from the previously indicated TCI state. For example, a UE may receive, from a BS, a set of TCI states (e.g., a higher layer configuration of “dl-OrJointTCI-StateList”) for unified TCI state. The multi-cell scheduling DCI may indicate one TCI state from the set of TCI states. In the context of the present disclosure, applying a TCI state can refer to that a UE assumes that the demodulation reference signal (DM-RS) of a PDSCH, the DM-RS of a PDCCH and the channel state information reference signal (CSI-RS) applying the TCI state are quasi co-located with the synchronization signal/physical broadcast channel (SS/PBCH) block the UE identified during the initial access procedure.

Embodiments of the present disclosure provide various solutions for HARQ-ACK information bit generation for a multi-cell scheduling DCI which indicates a TCI update. Embodiments of the present disclosure ensure the same understanding of the TCI update between the BS and UE based on the generated HARQ-ACK information. More details on the embodiments of the present disclosure will be illustrated in the following text in combination with the appended drawings.

In the context of the present application, for a set of serving cells (denoted as cell set #Z1) configured for multi-cell scheduling, it is assuming that a maximum of M cells can be co-scheduled by a multi-cell scheduling DCI in the same PUCCH group.

In some embodiments, a UE may generate two HARQ-ACK sub-codebooks (denoted as “sub-codebook #1” and “sub-codebook #2”) for a Type-2 (or dynamic) HARQ-ACK codebook.

In some embodiments, sub-codebook #1 may include HARQ-ACK information bits for PDSCH receptions scheduled by respective DCIs with each DCI scheduling one PDSCH or HARQ-ACK information bits for DCIs without scheduling any PDSCH with required HARQ-ACK feedback. For example, sub-codebook #1 may include HARQ-ACK feedback for DCI(s) having a single HARQ-ACK information bit. That is, a single HARQ-ACK information bit may be generated in sub-codebook #1 for each DCI associated with this sub-codebook.

For example, sub-codebook #1 may include HARQ-ACK information bits for PDSCHs respectively scheduled by DCI format 1_0, DCI format 1_1, DCI format 1_2 and DCI format 1_3 scheduling one PDSCH, and HARQ-ACK information bits for DCI(s) which does not schedule any PDSCH and is transmitted for a DL semi-persistent scheduling (SPS) PDSCH release, TCI update, SCell dormancy indication or other purposes.

In some embodiments, sub-codebook #2 may include HARQ-ACK information bits corresponding to the remaining DCIs that are not associated with sub-codebook #1 in DCIs with corresponding HARQ-ACK information bits to be transmitted in the same HARQ-ACK codebook (e.g., in the same PUCCH). For example, sub-codebook #2 may include HARQ-ACK feedback for DCI(s) having more than one HARQ-ACK information bit. That is, more than one HARQ-ACK information bit may be generated in sub-codebook #2 for each DCI associated with this sub-codebook.

For example, sub-codebook #2 may include (1) HARQ-ACK information bits for PDSCHs scheduled by respective DCIs (e.g., DCI formats 1_3), with each DCI format 1_3 scheduling more than one PDSCH, (2) HARQ-ACK information bits for one or more PDSCHs scheduled by a DCI format 1_3 (denoted as DCI #J), and (3) a HARQ-ACK information bit for SCell dormancy indication, where DCI #J schedules the one or more PDSCHs and indicates the SCell dormancy. For example, a DCI associated with sub-codebook #2 may be a DCI (e.g., DCI format 1_3) scheduling more than one PDSCH, or a DCI (e.g., DCI format 1_3) scheduling one or more PDSCHs and indicating SCell dormancy.

In some embodiments, the number of HARQ-ACK information bits for each DCI associated with sub-codebook #2 (e.g., multi-cell scheduling DCI such as DCI format 1_3) may be based on a maximum number of HARQ-ACK information bits per DCI (e.g., DCI format 1_3) among all the DCIs in the same PUCCH group. For example, the number of HARQ-ACK information bits per each DCI in sub-codebook #2 may be based on (e.g., equal to) the maximum number of cells co-scheduled by one multi-cell scheduling DCI (e.g., DCI format 1_3). For example, the number of HARQ-ACK information bits per each DCI in sub-codebook #2 may be based on a predefined number (e.g., based on the value of M or equal to 4).

In some embodiments, sub-codebook #1 may be placed in front of sub-codebook #2. In some embodiments, sub-codebook #2 may be placed in front of sub-codebook #1.

In some embodiments of the present disclosure, a TCI state indicated by a multi-cell scheduling DCI may be applied in response to the HARQ-ACK information bit(s) for the multi-cell scheduling DCI including at least one ACK bit.

In some embodiments of the present disclosure, when a UE receives a multi-cell scheduling DCI from a BS, the UE may generate one or more HARQ-ACK information bits for the DCI and transmit the generated HARQ-ACK information bit(s) in a HARQ-ACK codebook on a PUCCH or PUSCH to the BS. The DCI may indicate a TCI state different from a previously indicated TCI state. The UE may apply the indicated TCI state in response to that the generated one or more HARQ-ACK information bits for the DCI includes at least one ACK bit. In other words, the TCI state is not applied only when all the generated HARQ-ACK information bits for the DCI are NACK bits. Accordingly, in response to the BS receiving HARQ-ACK information bits for the DCI including at least one ACK bit, the BS may apply the indicated TCI state. For example, the TCI state may be applied starting from the first slot that is at least beamAppTime symbols after the last symbol of the PUCCH or the PUSCH. If the DCI is not received by the UE, one or more NACK bits may be generated for the DCI, and thus the UE and the BS would not apply the indicated TCI state.

For example, in some embodiments of the present disclosure, a multi-cell scheduling DCI (denoted as DCI #A) may indicate a TCI state different from a previously indicated TCI state.

In some embodiments, DCI #A may schedule a single PDSCH on a single serving cell within cell set #Z1. The UE may generate the corresponding HARQ-ACK information bit for the single PDSCH according to the decoding outcome. For example, an ACK bit is generated if the single PDSCH is correctly decoded by the UE, or a NACK bit is generated if the single PDSCH is not correctly decoded or DCI #A is not received by the UE. In some examples, the single HARQ-ACK information bit for the single PDSCH may be included in sub-codebook #1 and may be transmitted on a PUCCH or PUSCH.

If the HARQ-ACK information bit for the single PDSCH is an ACK bit, the UE may apply the indicated TCI state. Accordingly, in response to receiving the ACK bit for the single PDSCH scheduled by the DCI, the BS may apply the indicated TCI state. For example, the TCI state may be applied starting from the first slot that is at least beamAppTime symbols after the last symbol of the PUCCH or the PUSCH. Otherwise, if the HARQ-ACK information bit for the single PDSCH or for the missed DCI is a NACK bit, the UE may not apply the indicated TCI state. Accordingly, in response to receiving the NACK bit, the BS may not apply the indicated TCI state.

In some embodiments, DCI #A may indicate SCell dormancy and does not schedule a PDSCH on any cell within cell set #Z1. For example, DCI #A may indicate SCell dormancy by reinterpreting (or repurposing) a predefined set of DCI fields corresponding to a certain serving cell (denoted as cell #A1) in cell set #Z1. Cell #A1 may be a serving cell having a corresponding invalid frequency domain resource assignment (FDRA) value in DCI #A. For example, cell #A1 may be a serving cell with a predefined cell index (e.g., smallest cell index) among cells having corresponding invalid FDRA values in DCI #A. The predefined set of DCI fields may include one or more of the following fields corresponding to cell #A1: modulation coding scheme (MCS) of transport block 1 (TB1), new data indicator (NDI) of TB1, redundancy version (RV) of TB1, and HARQ process number. In the context of the present disclosure, cell #A1 can be referred to as a serving cell “virtually” scheduled by DCI #A. In other words, a “virtual” PDSCH is assumed to be scheduled on cell #A1 by DCI #A. The invalid FDRA value in the present disclosure may refer to that all bits of frequency domain resource assignment in the DCI are set to 0 for resource allocation type 0, or set to 1 for resource allocation type 1, or set to 0 or 1 for dynamic switch resource allocation type. The valid FDRA value in the present disclosure may refer to that at least one bit of frequency domain resource assignment in the DCI is not set to 0 for resource allocation type 0, or not set to 1 for resource allocation type 1, or not set to 0 or 1 for dynamic switch resource allocation type.

The UE may generate a single ACK bit as the corresponding HARQ-ACK information bit for DCI #A if DCI #A is received by the UE. That is, the “virtual” PDSCH is assumed as providing one transport block that has been correctly decoded by the UE. The generated HARQ-ACK information bit may be included in sub-codebook #1 and may be transmitted on a PUCCH or a PUSCH. The UE may apply the TCI state indicated by DCI #A after a time offset from the PUCCH or the PUSCH. For example, the TCI state may be applied starting from the first slot that is at least beamAppTime symbols after the last symbol of the PUCCH or the PUSCH. Accordingly, in response to receiving the ACK bit for DCI #A, the BS may apply the TCI state indicated by DCI #A. Otherwise, if DCI #A is not received by the UE, a NACK bit may be generated for DCI #A, and thus the UE and the BS would not apply the indicated TCI state.

In some embodiments of the present disclosure, DCI #A may schedule a plurality of PDSCHs (e.g., N2 PDSCHs, where N2 >1) on a set of serving cells (denoted as cell set #Z2) within cell set #Z1. The UE may generate corresponding HARQ-ACK information bits for the plurality of PDSCHs according to the decoding outcomes. For example, an ACK bit is generated if a corresponding PDSCH is correctly decoded by the UE, or a NACK bit is generated if a corresponding PDSCH is not correctly decoded or DCI #A is not received by the UE. The UE may generate N2 HARQ-ACK information bits for the N2 scheduled PDSCHs. The generated HARQ-ACK information bits may be included in sub-codebook #2 and may be transmitted on a PUCCH or a PUSCH. The number of HARQ-ACK information bits per each DCI in sub-codebook #2 may be equal to M.

If the N2 HARQ-ACK information bits for the N2 scheduled PDSCHs include at least one ACK bit, the UE may apply the indicated TCI state. Accordingly, in response to receiving the at least one ACK bit, the BS may apply the indicated TCI state. For example, the TCI state may be applied starting from the first slot that is at least beamAppTime symbols after the last symbol of the PUCCH or the PUSCH. Otherwise, if the HARQ-ACK information bits for the plurality of scheduled PDSCHs are all NACK bits or DCI #A is not received by the UE, the UE and the BS may not apply the indicated TCI state.

In some examples, if N2<M, M−N2 padding bits (e.g., NACK bits) may be generated by the UE and added (e.g., appended) to the HARQ-ACK information bits for the N2 PDSCHs to match the M HARQ-ACK information bits per DCI. That is, sub-codebook #2 includes a total of M HARQ-ACK information bits for DCI #A with M−N2 padding bits.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. HARQ-ACK information bits (or HARQ-ACK codebook) for DCI 311 is to be transmitted on PUCCH 315. Assuming that the UE correctly decodes PDSCH 313 but fails to decode PDSCH 323, the UE may generate an ACK for PDSCH 313 and a NACK for PDSCH 323. Assuming that M=4, then two padding bits should be added and the HARQ-ACK information bits for DCI 311 may be generated as {ACK, NACK, NACK, NACK}. Both the UE and the BS would apply the TCI state indicated by DCI 311 since the generated HARQ-ACK information bits for DCI 311 include one ACK bit. For example, the TCI state may be applied at 319, after time offset 317 relative to PUCCH 315.

In some embodiments of the present disclosure, DCI #A may schedule at least one PDSCH (e.g., N3 PDSCHs, where N3≥1) on a set of serving cells (denoted as cell set #Z3) within cell set #Z1. DCI #A may simultaneously indicate SCell dormancy by reinterpreting (or repurposing) a predefined set of DCI fields corresponding to a certain serving cell (denoted as cell #A3) in cell set #Z1. For example, cell #A3 may be a serving cell with a predefined cell index (e.g., smallest cell index) among cells having corresponding invalid FDRA values in DCI #A. HARQ-ACK information bits for DCI #A may be included in sub-codebook #2 and may be transmitted on a PUCCH or a PUSCH. The number of HARQ-ACK information bits per each DCI in sub-codebook #2 may be equal to M.

A “virtual” PDSCH is assumed to be scheduled on cell #A3 by DCI #A. The HARQ-ACK information for SCell dormancy indication corresponds to the HARQ-ACK information for the “virtual” PDSCH. That is, the UE may generate an ACK bit for the “virtual” PDSCH if DCI #A is received by the UE.

The UE may further generate corresponding HARQ-ACK information bit(s) for the at least one actually scheduled PDSCH according to the decoding outcomes. For example, an ACK bit is generated if a corresponding PDSCH is correctly decoded by the UE, or a NACK bit is generated if a corresponding PDSCH is not correctly decoded or DCI #A is not received by the UE. The UE may generate N3 HARQ-ACK information bits for the N3 scheduled PDSCHs. Therefore, before padding, N3+1 HARQ-ACK information bits may be generated for DCI #A. Since the N3+1 HARQ-ACK information bits include an ACK bit for SCell dormancy indication, both the UE and the BS may apply the indicated TCI state. For example, the TCI state may be applied starting from the first slot that is at least beamAppTime symbols after the last symbol of the PUCCH or the PUSCH. Otherwise, if DCI #A is not received by the UE, one or more NACK bits (e.g., M NACK bits) may be generated for DCI #A, and thus the UE and the BS would not apply the indicated TCI state.

In some examples, if N3+1<M, M−N3−1 padding bits (e.g., NACK bits) may be generated by the UE and added (e.g., appended) to the HARQ-ACK information bits for the N3 PDSCHs and SCell dormancy indication to match the M HARQ-ACK information bits per DCI. That is, sub-codebook #2 includes a total of M HARQ-ACK information bits for DCI #A with M−N3−1 padding bits.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. DCI 311 may further indicate SCell dormancy by repurposing a set of DCI fields corresponding to cell 363. HARQ-ACK information bits (or HARQ-ACK codebook) for DCI 311 is to be transmitted on PUCCH 315. Assuming that the UE fails to decode PDSCH 313 and PDSCH 323, the UE may generate respective NACK bits for PDSCH 313 and PDSCH 323. The UE may generate an ACK bit for the SCell dormancy indication. That is, the UE may generate an ACK bit corresponding to the “virtual” PDSCH on cell 363. Assuming that M=4, then one padding bit should be added and the HARQ-ACK information bits for DCI 311 may be generated as {NACK, NACK, ACK, NACK}. Both the UE and the BS would apply the TCI state indicated by DCI 311 since the generated HARQ-ACK information bits for DCI 311 include one ACK bit. For example, the TCI state may be applied at 319, after time offset 317 relative to PUCCH 315.

In some embodiments of the present disclosure, when generating HARQ-ACK information bit(s) for a multi-cell scheduling DCI, the UE may generate an ACK bit for indicating a reception of the DCI. In such a scenario, the HARQ-ACK information bits for the DCI include at least one ACK bit. Therefore, the UE and the BS would apply the indicated TCI state in response to the ACK bit for indicating the reception of the DCI.

For example, in some embodiments of the present disclosure, a multi-cell scheduling DCI (denoted as DCI #B) may indicate a TCI state different from a previously indicated TCI state.

In some embodiments, DCI #B may schedule a single PDSCH on a single serving cell within cell set #Z1. The UE may generate the corresponding HARQ-ACK information bit for the single PDSCH according to the decoding outcome. For example, an ACK bit is generated if the single PDSCH is correctly decoded by the UE, or a NACK bit is generated if the single PDSCH is not correctly decoded or DCI #B is not received by the UE. In some examples, the single HARQ-ACK information bit for the single PDSCH may be included in sub-codebook #1 and may be transmitted on a PUCCH or PUSCH.

If the HARQ-ACK information bit for the single PDSCH is an ACK bit, the UE may apply the indicated TCI state. Accordingly, in response to receiving the ACK bit for the single PDSCH scheduled by the DCI, the BS may apply the indicated TCI state. For example, the TCI state may be applied starting from the first slot that is at least beamAppTime symbols after the last symbol of the PUCCH or the PUSCH. Otherwise, if the HARQ-ACK information bit for the single PDSCH or for the missed DCI is a NACK bit, the UE may not apply the indicated TCI state. Accordingly, in response to receiving the NACK bit, the BS may not apply the indicated TCI state.

In some embodiments, DCI #B may indicate SCell dormancy and does not schedule a PDSCH on any cell within cell set #Z1. For example, DCI #B may indicate SCell dormancy by reinterpreting (or repurposing) a predefined set of DCI fields corresponding to a certain serving cell (denoted as cell #B1) in cell set #Z1. For example, cell #B1 may be a serving cell with a predefined cell index (e.g., smallest cell index) among cells having corresponding invalid FDRA values in DCI #B. A “virtual” PDSCH is assumed to be scheduled on cell #B1 by DCI #B. The HARQ-ACK information for SCell dormancy indication corresponds to the HARQ-ACK information for the “virtual” PDSCH. That is, the UE may generate an ACK bit for the “virtual” PDSCH if DCI #B is received by the UE. This ACK bit can also be referred to as an ACK bit for indicating the reception of DCI #B.

The generated HARQ-ACK information bit (i.e., an ACK) may be included in sub-codebook #1 and may be transmitted on a PUCCH or a PUSCH. The UE may apply the TCI state indicated by DCI #B after a time offset from the PUCCH or the PUSCH. For example, the TCI state may be applied starting from the first slot that is at least beamAppTime symbols after the last symbol of the PUCCH or the PUSCH. Accordingly, in response to receiving the ACK bit for DCI #B, the BS may apply the TCI state indicated by DCI #B. Otherwise, if DCI #B is not received by the UE, a NACK bit may be generated for DCI #B, and thus the UE and the BS would not apply the indicated TCI state.

In some embodiments of the present disclosure, DCI #B may schedule a plurality of PDSCHs (e.g., N4 PDSCHs, where M>N4>1) on a set of serving cells (denoted as cell set #Z4) within cell set #Z1. The UE may generate corresponding HARQ-ACK information bits for the plurality of PDSCHs according to the decoding outcomes. For example, an ACK bit is generated if a corresponding PDSCH is correctly decoded by the UE, or a NACK bit is generated if a corresponding PDSCH is not correctly decoded. The UE may generate N4 HARQ-ACK information bits for the N4 scheduled PDSCHs. The generated HARQ-ACK information bits may be included in sub-codebook #2 and may be transmitted on a PUCCH or a PUSCH. The number of HARQ-ACK information bits per each DCI in sub-codebook #2 may be equal to M.

In some embodiments, if DCI #B is received by the UE, the UE may generate an ACK bit for indicating the reception of DCI #B. This ACK bit may act as a padding bit. For example, this ACK padding bit may be prepended or appended to the HARQ-ACK information bits for the N4 PDSCHs. Otherwise, if DCI #B is not received by the UE, the UE may generate a predefined number (e.g., M) of NACK bits for DCI #B.

In some embodiments, M−N4−1 padding bits of NACK may be generated in addition to the HARQ-ACK information bits for the N4 PDSCHs and the padding bit of ACK so as to match the M HARQ-ACK information bits per DCI. In some examples, the padding bits of NACK may be placed at a predefined location of the M bits. For example, the padding bits of NACK may be appended to the HARQ-ACK information bits for the N4 PDSCHs. In some examples, the padding bit of ACK may be placed at a predefined location of the M bits. For example, the padding bit of ACK may be placed at the end or beginning of the M bits. The M HARQ-ACK information bits for DCI #B may be included in sub-codebook #2 and may be transmitted on the PUCCH or the PUSCH.

If the generated HARQ-ACK information bits for DCI #B (e.g., the M bits or the N4+1 bits) include at least one ACK bit, the UE may apply the indicated TCI state. Accordingly, in response to receiving the at least one ACK bit, the BS may apply the indicated TCI state. For example, the TCI state may be applied starting from the first slot that is at least beamAppTime symbols after the last symbol of the PUCCH or the PUSCH. Otherwise, if the HARQ-ACK information bits for the plurality of scheduled PDSCHs are all NACK bits or DCI #B is not received by the UE, the UE and the BS may not apply the indicated TCI state.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. HARQ-ACK information bits (or HARQ-ACK codebook) for DCI 311 is to be transmitted on PUCCH 315. Assuming that the UE fails to decode PDSCH 313 and PDSCH 323, the UE may generate respective NACK bits for PDSCH 313 and PDSCH 323. The UE may generate an ACK bit for indicating the reception of DCI 311, which may act as a padding bit. Assuming that M=4, then one additional padding bit of NACK should be added and the HARQ-ACK information bits for DCI 311 may be generated as {NACK, NACK, NACK, ACK}. That is, the ACK bit for indicating the reception of DCI 311 is placed at the end of M bits for DCI 311. Both the UE and the BS would apply the TCI state indicated by DCI 311 since the generated HARQ-ACK information bits for DCI 311 include one ACK bit. For example, the TCI state may be applied at 319, after time offset 317 relative to PUCCH 315.

In some embodiments of the present disclosure, DCI #B may schedule a plurality of PDSCHs (e.g., M PDSCHs) on a set of serving cells (denoted as cell set #Z5) within cell set #Z1. The UE may generate corresponding HARQ-ACK information bits for the plurality of PDSCHs according to the decoding outcomes. For example, an ACK bit is generated if a corresponding PDSCH is correctly decoded by the UE, or a NACK bit is generated if a corresponding PDSCH is not correctly decoded. The UE may generate corresponding HARQ-ACK information bits for the M scheduled PDSCHs. The generated HARQ-ACK information bits may be included in sub-codebook #2 and may be transmitted on a PUCCH or a PUSCH. The number of HARQ-ACK information bits per each DCI in sub-codebook #2 may be equal to M. Otherwise, if DCI #B is not received by the UE, the UE may generate a predefined number (e.g., M) of NACK bits for DCI #B.

If the generated HARQ-ACK information bits for the M scheduled PDSCHs include at least one ACK bit, the UE may apply the indicated TCI state. Accordingly, in response to receiving the at least one ACK bit, the BS may apply the indicated TCI state. For example, the TCI state may be applied starting from the first slot that is at least beamAppTime symbols after the last symbol of the PUCCH or the PUSCH. Otherwise, if the HARQ-ACK information bits for M scheduled PDSCHs are all NACK bits or DCI #B is not received by the UE, the UE and the BS may not apply the indicated TCI state.

In some embodiments of the present disclosure, DCI #B may schedule at least one PDSCH (e.g., N5 ≥1 PDSCHs) on a set of serving cells (denoted as cell set #Z5) within cell set #Z1. DCI #B may simultaneously indicate SCell dormancy by reinterpreting (or repurposing) a predefined set of DCI fields corresponding to a certain serving cell (denoted as cell #B5) in cell set #Z1. For example, cell #B5 may be a serving cell with a predefined cell index (e.g., smallest cell index) among cells having corresponding invalid FDRA values in DCI #B. HARQ-ACK information bits for DCI #B may be included in sub-codebook #2 and may be transmitted on a PUCCH or a PUSCH. The number of HARQ-ACK information bits per each DCI in sub-codebook #2 may be equal to M.

A “virtual” PDSCH is assumed to be scheduled on cell #B5 by DCI #B. The HARQ-ACK information for SCell dormancy indication corresponds to the HARQ-ACK information for the “virtual” PDSCH. That is, the UE may generate an ACK bit for the “virtual” PDSCH if DCI #B is received by the UE. This ACK bit can also be referred to as an ACK bit for indicating the reception of DCI #B.

The UE may further generate corresponding HARQ-ACK information bit(s) for the at least one actually scheduled PDSCH according to the decoding outcomes. For example, an ACK bit is generated if a corresponding PDSCH is correctly decoded by the UE, or a NACK bit is generated if a corresponding PDSCH is not correctly decoded or DCI #B is not received by the UE. The UE may generate N5 HARQ-ACK information bits for the N5 scheduled PDSCHs. Therefore, before padding, N5+1 HARQ-ACK information bits may be generated for DCI #B. Since the N5+1 HARQ-ACK information bits include an ACK bit for SCell dormancy indication, both the UE and the BS may apply the indicated TCI state. For example, the TCI state may be applied starting from the first slot that is at least beamAppTime symbols after the last symbol of the PUCCH or the PUSCH. Otherwise, if DCI #B is not received by the UE, a NACK bit (e.g., M NACK bits) may be generated for DCI #B, and thus the UE and the BS would not apply the indicated TCI state.

In some examples, if N5+1 <M, M−N5−1 padding bits (e.g., NACK bits) may be generated by the UE and added (e.g., appended) to the HARQ-ACK information bits for the N5 PDSCHs and SCell dormancy indication to match the M HARQ-ACK information bits per DCI. That is, sub-codebook #2 includes a total of M HARQ-ACK information bits for DCI #B with M−N5−1 padding bits.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. DCI 311 may further indicate SCell dormancy by repurposing a set of DCI fields corresponding to cell 363. HARQ-ACK information bits (or HARQ-ACK codebook) for DCI 311 is to be transmitted on PUCCH 315. Assuming that the UE fails to decode PDSCH 313 and PDSCH 323, the UE may generate respective NACK bits for PDSCH 313 and PDSCH 323. The UE may generate an ACK bit for the SCell dormancy indication. That is, the UE may generate an ACK bit corresponding to the “virtual” PDSCH on cell 363. Assuming that M=4, then one padding bit should be added and the HARQ-ACK information bits for DCI 311 may be generated as {NACK, NACK, ACK, NACK}. Both the UE and the BS would apply the TCI state indicated by DCI 311 since the generated HARQ-ACK information bits for DCI 311 include one ACK bit. For example, the TCI state may be applied at 319, after time offset 317 relative to PUCCH 315.

For example, in some embodiments of the present disclosure, a multi-cell scheduling DCI (denoted as DCI #C) may indicate a TCI state different from a previously indicated TCI state.

In some embodiments, DCI #C may schedule a single PDSCH on a single serving cell within cell set #Z1. The UE may generate the corresponding HARQ-ACK information bit for the single PDSCH according to the decoding outcome. For example, an ACK bit is generated if the single PDSCH is correctly decoded by the UE, or a NACK bit is generated if the single PDSCH is not correctly decoded or DCI #C is not received by the UE. In some examples, the single HARQ-ACK information bit for the single PDSCH may be included in sub-codebook #1 and may be transmitted on a PUCCH or PUSCH.

If the HARQ-ACK information bit for the single PDSCH is an ACK bit, the UE may apply the indicated TCI state. Accordingly, in response to receiving the ACK bit for the single PDSCH scheduled by the DCI, the BS may apply the indicated TCI state. For example, the TCI state may be applied starting from the first slot that is at least beamAppTime symbols after the last symbol of the PUCCH or the PUSCH. Otherwise, if the HARQ-ACK information bit for the single PDSCH or for the missed DCI is a NACK bit, the UE may not apply the indicated TCI state. Accordingly, in response to receiving the NACK bit, the BS may not apply the indicated TCI state.

In some embodiments, DCI #C may indicate SCell dormancy and does not schedule a PDSCH on any cell within cell set #Z1. For example, DCI #C may indicate SCell dormancy by reinterpreting (or repurposing) a predefined set of DCI fields corresponding to a certain serving cell (denoted as cell #C1) in cell set #Z1. For example, cell #C1 may be a serving cell with a predefined cell index (e.g., smallest cell index) among cells having corresponding invalid FDRA values in DCI #C. A “virtual” PDSCH is assumed to be scheduled on cell #C1 by DCI #C. The HARQ-ACK information for SCell dormancy indication corresponds to the HARQ-ACK information for the “virtual” PDSCH. That is, the UE may generate an ACK bit for the “virtual” PDSCH if DCI #C is received by the UE. This ACK bit can also be referred to as an ACK bit for indicating the reception of DCI #C.

The generated HARQ-ACK information bit (i.e., an ACK) may be included in sub-codebook #1 and may be transmitted on a PUCCH or a PUSCH. The UE may apply the TCI state indicated by DCI #C after a time offset from the PUCCH or the PUSCH. For example, the TCI state may be applied starting from the first slot that is at least beamAppTime symbols after the last symbol of the PUCCH or the PUSCH. Accordingly, in response to receiving the ACK bit for DCI #C, the BS may apply the TCI state indicated by DCI #C. Otherwise, if DCI #C is not received by the UE, a NACK bit may be generated for DCI #C, and thus the UE and the BS would not apply the indicated TCI state.

In some embodiments of the present disclosure, DCI #C may schedule a plurality of PDSCHs (e.g., N6 PDSCHs, where N6>1) on a set of serving cells (denoted as cell set #Z6) within cell set #Z1. HARQ-ACK information bits for DCI #C may be included in sub-codebook #2 and may be transmitted on a PUCCH or a PUSCH.

In some embodiments, when generating HARQ-ACK information bit for a DCI (e.g., DCI #C) associated with sub-codebook #2, the UE may generate an ACK bit for indicating the reception of the DCI. Therefore, in addition to the maximum number of HARQ-ACK information bits per DCI among all the DCIs in the same PUCCH group or the maximum number of cells co-scheduled by one multi-cell scheduling DCI, such reception indication is taken into account when determining the number of HARQ-ACK information bits per each DCI in sub-codebook #2. For example, the number of HARQ-ACK information bits per each DCI in sub-codebook #2 may be equal to M+1.

The UE may generate corresponding HARQ-ACK information bits for the plurality of PDSCHs (e.g., N6 PDSCHs) according to the decoding outcomes. For example, an ACK bit is generated if a corresponding PDSCH is correctly decoded by the UE, or a NACK bit is generated if a corresponding PDSCH is not correctly decoded. For example, the UE may generate N6 HARQ-ACK information bits for the N6 scheduled PDSCHs.

In some embodiments, if DCI #C is received by the UE, the UE may generate an ACK bit for indicating the reception of DCI #C. This ACK bit may act as a padding bit. For example, this ACK padding bit may be prepended or appended to the HARQ-ACK information bits for the N6 PDSCHs. Otherwise, if DCI #C is not received by the UE, the UE may generate a predefined number (e.g., M+1) of NACK bits for DCI #C.

In some embodiments, M−N6 padding bits of NACK may be generated in addition to the HARQ-ACK information bits for the N6 PDSCHs and the ACK bit for indicating the reception of the DCI so as to match the M+1 HARQ-ACK information bits per DCI. In some examples, the padding bits of NACK may be placed at a predefined location of the M+1 bits. For example, the padding bits of NACK may be appended to the HARQ-ACK information bits for the N6 PDSCHs. In some examples, the ACK bit for indicating the reception of the DCI may be placed at a predefined location of the M+1 bits. For example, the ACK bit for indicating the reception of the DCI may be placed at the end or beginning of the M+1 bits. The M+1 HARQ-ACK information bits for DCI #C may be included in sub-codebook #2 and may be transmitted on a PUCCH or a PUSCH.

If the generated HARQ-ACK information bits for DCI #C (e.g., the M+1 bits or the N6+1 bits) include at least one ACK bit, the UE may apply the indicated TCI state. Accordingly, in response to receiving the at least one ACK bit, the BS may apply the indicated TCI state. For example, the TCI state may be applied starting from the first slot that is at least beamAppTime symbols after the last symbol of the PUCCH or the PUSCH. Otherwise, if DCI #C is not received by the UE, the UE and the BS may not apply the indicated TCI state.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. HARQ-ACK information bits (or HARQ-ACK codebook) for DCI 311 is to be transmitted on PUCCH 315. If DCI 311 is received by the UE, one ACK bit is generated for indicating the reception of the DCI. Assuming that M=4, then this ACK bit of reception indicating may be placed at the 5^{th} bit among the 5 HARQ-ACK information bits for DCI 311. Assuming that the UE fails to decode PDSCH 313 and PDSCH 323, the UE may generate respective NACK bits for PDSCH 313 and PDSCH 323. The UE may further generate two padding bits of NACK, which is appended to the NACK bits for PDSCH 313 and PDSCH 323. Therefore, the HARQ-ACK information bits for DCI 311 may be generated as {NACK, NACK, NACK, NACK, ACK}. Both the UE and the BS would apply the TCI state indicated by DCI 311 since the generated HARQ-ACK information bits for DCI 311 include one ACK bit. For example, the TCI state may be applied at 319, after time offset 317 relative to PUCCH 315. Otherwise, if DCI 311 is not received by the UE, the HARQ-ACK information bits for DCI 311 may be generated as {NACK, NACK, NACK, NACK, NACK}. Both the UE and the BS would not apply the updated TCI state.

In some embodiments of the present disclosure, DCI #C may schedule at least one of PDSCHs (e.g., N7 PDSCHs, where N7≥1) on a set of serving cells (denoted as cell set #Z7) within cell set #Z1 and simultaneously indicate SCell dormancy. For example, DCI #C may indicate the SCell dormancy by reinterpreting (or repurposing) a predefined set of DCI fields corresponding to a certain serving cell (denoted as cell #C7) in cell set #Z1. For example, cell #C7 may be a serving cell with a predefined cell index (e.g., smallest cell index) among cells having corresponding invalid FDRA values in DCI #C. HARQ-ACK information bits for DCI #C may be included in sub-codebook #2 and may be transmitted on a PUCCH or a PUSCH.

In some embodiments, when generating HARQ-ACK information bit for a DCI (e.g., DCI #C) associated with sub-codebook #2, the UE may generate an ACK bit for indicating the reception of the DCI. Therefore, in addition to the maximum number of HARQ-ACK information bits per DCI among all the DCIs in the same PUCCH group or the maximum number of cells co-scheduled by one multi-cell scheduling DCI, such reception indication is taken into account when determining the number of HARQ-ACK information bits per each DCI in sub-codebook #2. For example, the number of HARQ-ACK information bits per each DCI in sub-codebook #2 may be equal to M+1.

The UE may generate corresponding HARQ-ACK information bits for the at least one of PDSCHs (e.g., N7 PDSCHs) scheduled by DCI #C according to the decoding outcomes. For example, an ACK bit is generated if a corresponding PDSCH is correctly decoded by the UE, or a NACK bit is generated if a corresponding PDSCH is not correctly decoded. For example, the UE may generate N7 HARQ-ACK information bits for the N7 scheduled PDSCHs.

A “virtual” PDSCH is assumed to be scheduled on cell #C7 by DCI #C. The HARQ-ACK information for SCell dormancy indication corresponds to the HARQ-ACK information for the “virtual” PDSCH. That is, the UE may further generate an ACK bit for the “virtual” PDSCH if DCI #C is received by the UE.

In some embodiments, if DCI #C is received by the UE, the UE may generate an ACK bit for indicating the reception of DCI #C. This ACK bit may act as a padding bit. For example, this ACK padding bit may be prepended or appended to the HARQ-ACK information bits for the N7 PDSCHs. Otherwise, if DCI #C is not received by the UE, the UE may generate a predefined number (e.g., M+1) of NACK bits for DCI #C.

In some embodiments, M−N7−1 padding bits of NACK may be generated in addition to the HARQ-ACK information bits for the N7 PDSCHs, the ACK bit for the “virtual” PDSCH and the ACK bit for indicating the reception of the DCI so as to match the M+1 HARQ-ACK information bits per DCI. In some examples, the padding bits of NACK may be placed at a predefined location of the M+1 bits. For example, the padding bits of NACK may be appended to the HARQ-ACK information bits for the N7 PDSCHs and the ACK bit for the “virtual” PDSCH. In some examples, the ACK bit for indicating the reception of the DCI may be placed at a predefined location of the M+1 bits. For example, the ACK bit for indicating the reception of the DCI may be placed at the end or beginning of the M+1 bits. The M+1 HARQ-ACK information bits for DCI #C may be included in sub-codebook #2 and may be transmitted on a PUCCH or a PUSCH.

If the generated HARQ-ACK information bits for DCI #C (e.g., the M+1 bits or the N7+2 bits) include at least one ACK bit, the UE may apply the indicated TCI state. Accordingly, in response to receiving the at least one ACK bit, the BS may apply the indicated TCI state. For example, the TCI state may be applied starting from the first slot that is at least beamAppTime symbols after the last symbol of the PUCCH or the PUSCH. Otherwise, if DCI #C is not received by the UE, the UE and the BS may not apply the indicated TCI state.

For example, referring to FIG. 3, a UE may be configured with cells 361-364 for multi-cell scheduling. DCI 311 may schedule PDSCH 313 on cell 361 and PDSCH 323 on cell 362 and indicate a TCI state from the previously indicated TCI state. DCI 311 may further indicate SCell dormancy by repurposing a set of DCI fields corresponding to cell 363. HARQ-ACK information bits (or HARQ-ACK codebook) for DCI 311 is to be transmitted on PUCCH 315. If DCI 311 is received by the UE, one ACK bit is generated for indicating the reception of the DCI. Assuming that M=4, then this ACK bit of reception indicating may be placed at the 5^{th} bit among the 5 HARQ-ACK information bits for DCI 311. Assuming that the UE fails to decode PDSCH 313 and PDSCH 323, the UE may generate respective NACK bits for PDSCH 313 and PDSCH 323. The UE may further generate one padding bit of NACK, which is appended to the NACK bits for PDSCH 313 and PDSCH 323 and the ACK bit for the virtual PDSCH on cell 363. Therefore, the HARQ-ACK information bits for DCI 311 may be generated as {NACK, NACK, ACK, NACK, ACK}. Both the UE and the BS would apply the TCI state indicated by DCI 311 since the generated HARQ-ACK information bits for DCI 311 include two ACK bits. For example, the TCI state may be applied at 319, after time offset 317 relative to PUCCH 315. Otherwise, if DCI 311 is not received by the UE, the HARQ-ACK information bits for DCI 311 may be generated as {NACK, NACK, NACK, NACK, NACK}. Both the UE and the BS would not apply the updated TCI state.

In some embodiments of the present disclosure, when a UE receives a multi-cell scheduling DCI from a BS, the UE may generate one or multiple HARQ-ACK information bits for the DCI and transmit the generated HARQ-ACK information bit(s) in a HARQ-ACK codebook on a PUCCH or PUSCH to the BS. The DCI may indicate a TCI state different from a previously indicated TCI state. The UE may apply the indicated TCI state in response to all HARQ-ACK information bits excluding (possible) padding bits in the HARQ-ACK codebook being ACK bits. In other words, if the HARQ-ACK information bit(s) for the PDSCH(s) actually scheduled by the DCI includes at least one NACK bit, the indicated TCI state is not applied. Accordingly, the BS may apply the indicated TCI state if all HARQ-ACK information bits for the DCI excluding (possible) padding bits are ACK bits. For example, the TCI state may be applied starting from the first slot that is at least beamAppTime symbols after the last symbol of the PUCCH or the PUSCH. If the DCI is not received by the UE, one or more NACK bits may be generated for the DCI, and thus the UE and the BS would not apply the indicated TCI state.

For example, in some embodiments, a multi-cell scheduling DCI format (denoted as DCI #D) may indicate a TCI state different from a previously indicated TCI state.

In some embodiments, DCI #D may schedule a single PDSCH on a single serving cell within cell set #Z1. The UE may generate the corresponding HARQ-ACK information bit for the single PDSCH according to the decoding outcome. For example, an ACK bit is generated if the single PDSCH is correctly decoded by the UE, or a NACK bit is generated if the single PDSCH is not correctly decoded or DCI #D is not received by the UE. In some examples, the single HARQ-ACK information bit for the single PDSCH may be included in sub-codebook #1 and may be transmitted on a PUCCH or PUSCH.

If the HARQ-ACK information bit for the single PDSCH is an ACK bit, the UE may apply the indicated TCI state. Accordingly, in response to receiving the ACK bit for the single PDSCH scheduled by the DCI, the BS may apply the indicated TCI state. For example, the TCI state may be applied starting from the first slot that is at least beamAppTime symbols after the last symbol of the PUCCH or the PUSCH. Otherwise, if the HARQ-ACK information bit for the single PDSCH or for the missed DCI is a NACK bit, the UE may not apply the indicated TCI state. Accordingly, in response to receiving the NACK bit, the BS may not apply the indicated TCI state.

In some embodiments, DCI #D may indicate SCell dormancy and does not schedule a PDSCH on any cell within cell set #Z1. For example, DCI #D may indicate SCell dormancy by reinterpreting (or repurposing) a predefined set of DCI fields corresponding to a certain serving cell (denoted as cell #D1) in cell set #Z1. For example, cell #D1 may be a serving cell with a predefined cell index (e.g., smallest cell index) among cells having corresponding invalid FDRA values in DCI #D. A “virtual” PDSCH is assumed to be scheduled on cell #D1 by DCI #D. The HARQ-ACK information for SCell dormancy indication corresponds to the HARQ-ACK information for the “virtual” PDSCH. That is, the UE may generate an ACK bit for the “virtual” PDSCH if DCI #D is received by the UE. This ACK bit can also be referred to as an ACK bit for indicating the reception of DCI #D.

The generated HARQ-ACK information bit (i.e., an ACK) may be included in sub-codebook #1 and may be transmitted on a PUCCH or a PUSCH. The UE may apply the TCI state indicated by DCI #D after a time offset from the PUCCH or the PUSCH. For example, the TCI state may be applied starting from the first slot that is at least beamAppTime symbols after the last symbol of the PUCCH or the PUSCH. Accordingly, in response to receiving the ACK bit for DCI #D, the BS may apply the TCI state indicated by DCI #D. Otherwise, if DCI #D is not received by the UE, a NACK bit may be generated for DCI #D, and thus the UE and the BS would not apply the indicated TCI state.

In some embodiments, DCI #D may schedule at least one PDSCH on a set of serving cells (denoted as cell set #Z8) within cell set #Z1. DCI #D may or may not indicate SCell dormancy. The UE may generate at least one HARQ-ACK information bit for the at least one PDSCH according to the decoding outcome. For example, an ACK is generated if a corresponding PDSCH is correctly decoded by the UE, or a NACK is generated if a corresponding PDSCH is not correctly decoded or DCI #D is not received by the UE. As long as one NACK bit is generated for the at least one PDSCH scheduled by DCI #D or DCI #D is not received by the UE, the UE and the BS would not apply the TCI state indicated by DCI #D. Otherwise, if all HARQ-ACK information bits for the at least one PDSCH scheduled by DCI #D are ACK bits, the UE and the BS would apply the indicated TCI state.

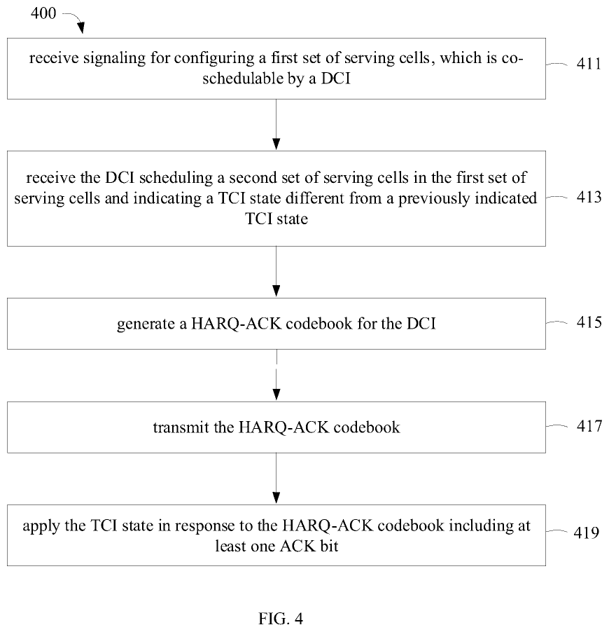

FIG. 4 illustrates a flowchart of method 400 for wireless communication in accordance with some embodiments of the present disclosure. Details described in all of the foregoing embodiments of the present disclosure are applicable for the embodiments shown in FIG. 4. In some examples, method 400 may be performed by a UE, for example, UE 104 as described with reference to FIG. 1. In some embodiments, the UE may execute a set of instructions to control the functional elements of the UE to perform the described functions or operations. In some examples, a processor of a UE may cause the UE to perform method 400.

At 411, a UE may receive signaling for configuring a first set of serving cells, which is co-schedulable by a DCI. At 413, the UE may receive the DCI scheduling a second set of serving cells in the first set of serving cells and indicating a TCI state different from a previously indicated TCI state. At 415, the UE may generate a HARQ-ACK codebook for the DCI. At 417, the UE may transmit the HARQ-ACK codebook. At 419, the UE may apply the TCI state in response to the HARQ-ACK codebook including at least one ACK bit.

In some embodiments, applying the TCI state in response to the HARQ-ACK codebook including at least one ACK bit includes applying the TCI state in response to that all HARQ-ACK information bits excluding padding bits in the HARQ-ACK codebook are ACK bits.

In some embodiments, generating the HARQ-ACK codebook for the DCI includes generating an ACK bit for indicating a reception of the DCI.

In some embodiments, the ACK bit for indicating the reception of the DCI is generated in response to one of the following: a number of serving cells in the second set of serving cells being greater than one and less than an allowable maximum number of serving cells co-schedulable by the DCI; the number of serving cells in the second set of serving cells being greater than one; and the number of serving cells in the second set of serving cells being greater than or equal to one and the DCI further indicating SCell dormancy.

In some embodiments, the ACK bit for indicating the reception of the DCI acts as a padding bit in the HARQ-ACK codebook.

In some embodiments, the ACK bit for indicating the reception of the DCI is arranged at a predefined position in the HARQ-ACK codebook.

In some embodiments, generating the HARQ-ACK codebook for the DCI includes: generating HARQ-ACK information bits for the second set of serving cells; and in response to a number of bits of the generated HARQ-ACK information bits being greater than one and less than a predefined number of HARQ-ACK information bits, adding at least one padding bit to the generated HARQ-ACK information bits to match the predefined number, wherein the at least one padding bit includes an ACK bit for indicating a reception of the DCI.

In some embodiments, generating the HARQ-ACK codebook for the DCI includes: generating HARQ-ACK information bits for the second set of serving cells; and in response to a number of bits of the generated HARQ-ACK information bits being greater than one, adding at least one padding bit to the generated HARQ-ACK information bits to match a predefined number of HARQ-ACK information bits; and generating an ACK bit for indicating a reception of the DCI.

In some embodiments, the DCI further indicates SCell dormancy. Generating the HARQ-ACK codebook for the DCI includes: generating HARQ-ACK information bits for the second set of serving cells and SCell dormancy indication; in response to a number of bits of the generated HARQ-ACK information bits being less than a predefined number of HARQ-ACK information bits, adding at least one padding bit to the generated HARQ-ACK information bits to match the predefined number; and generating an ACK bit for indicating a reception of the DCI.

In some embodiments, generating the HARQ-ACK codebook for the DCI includes in response to the second set of serving cells including a single serving cell, generating a NACK bit or an ACK bit corresponding to the single serving cell.

In some embodiments, the DCI further indicates SCell dormancy by reinterpreting a set of fields associated with a first serving cell of a third set of serving cells in the first set of serving cells, and wherein the HARQ-ACK codebook includes an ACK bit for the first serving cell.

It should be appreciated by persons skilled in the art that the sequence of the operations in exemplary method 400 may be changed and some of the operations in exemplary method 400 may be eliminated or modified, without departing from the spirit and scope of the disclosure.

FIG. 5 illustrates a flowchart of method 500 for wireless communication in accordance with some embodiments of the present disclosure. Details described in all of the foregoing embodiments of the present disclosure are applicable for the embodiments shown in FIG. 5. In some examples, method 500 may be performed by a BS or an NE (for example, NE 102 as described with reference to FIG. 1). In some embodiments, the BS or the NE may execute a set of instructions to control the functional elements of the BS or the NE to perform the described functions or operations. In some examples, a processor of an NE may cause the NE to perform method 500.

At 511, a BS may transmit, to a UE, signaling for configuring a first set of serving cells, which is co-schedulable by a DCI. At 513, the BS may transmit, to the UE, the DCI scheduling a second set of serving cells in the first set of serving cells and indicating a TCI state different from a previously TCI state indicated to the UE. At 515, the BS may receive, from the UE, a HARQ-ACK codebook for the DCI. At 517, the BS may apply the TCI state in response to the HARQ-ACK codebook including at least one ACK bit.

In some embodiments, applying the TCI state in response to the HARQ-ACK codebook including at least one ACK bit includes applying the TCI state in response to that all HARQ-ACK information bits excluding padding bits in the HARQ-ACK codebook are ACK bits.

In some embodiments, the at least one ACK bit in the HARQ-ACK codebook includes an ACK bit for indicating a reception of the DCI.

In some embodiments, the HARQ-ACK codebook includes the ACK bit for indicating the reception of the DCI in response to one of the following: a number of serving cells in the second set of serving cells being greater than one and less than an allowable maximum number of serving cells co-schedulable by the DCI; the number of serving cells in the second set of serving cells being greater than one; or the number of serving cells in the second set of serving cells being greater than or equal to one and the DCI further indicating SCell dormancy.

In some embodiments, the ACK bit for indicating the reception of the DCI acts as a padding bit in the HARQ-ACK codebook.

In some embodiments, the ACK bit for indicating the reception of the DCI is arranged at a predefined position in the HARQ-ACK codebook.

In some embodiments, the DCI further indicates SCell dormancy by reinterpreting a set of fields associated with a first serving cell of a third set of serving cells in the first set of serving cells, and wherein the HARQ-ACK codebook includes an ACK bit for the first serving cell.

It should be appreciated by persons skilled in the art that the sequence of the operations in exemplary method 500 may be changed and some of the operations in exemplary method 500 may be eliminated or modified, without departing from the spirit and scope of the disclosure.

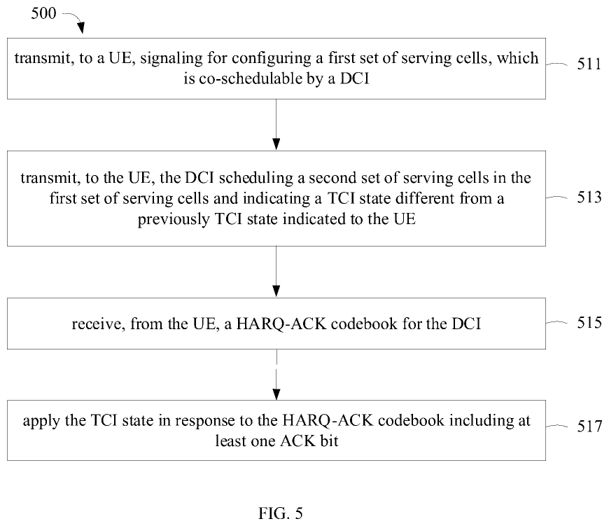

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. For example, the UE 600 may be configured to support means for performing the operations as described with respect to FIGS. 1-5.

For example, the UE 600 may be configured to support: a means for receiving signaling for configuring a first set of serving cells, which is co-schedulable by a DCI; a means for receiving the DCI scheduling a second set of serving cells in the first set of serving cells and indicating a TCI state different from a previously indicated TCI state; a means for generating a HARQ-ACK codebook for the DCI; a means for transmitting the HARQ-ACK codebook; and a means for applying the TCI state in response to the HARQ-ACK codebook including at least one ACK bit.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, or packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, or packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

It should be appreciated by persons skilled in the art that the components in exemplary UE 600 may be changed, for example, some of the components in exemplary UE 600 may be omitted or modified or a new component(s) may be added to exemplary UE 600, without departing from the spirit and scope of the disclosure. For example, in some embodiments, the UE 600 may not include the controller 606.

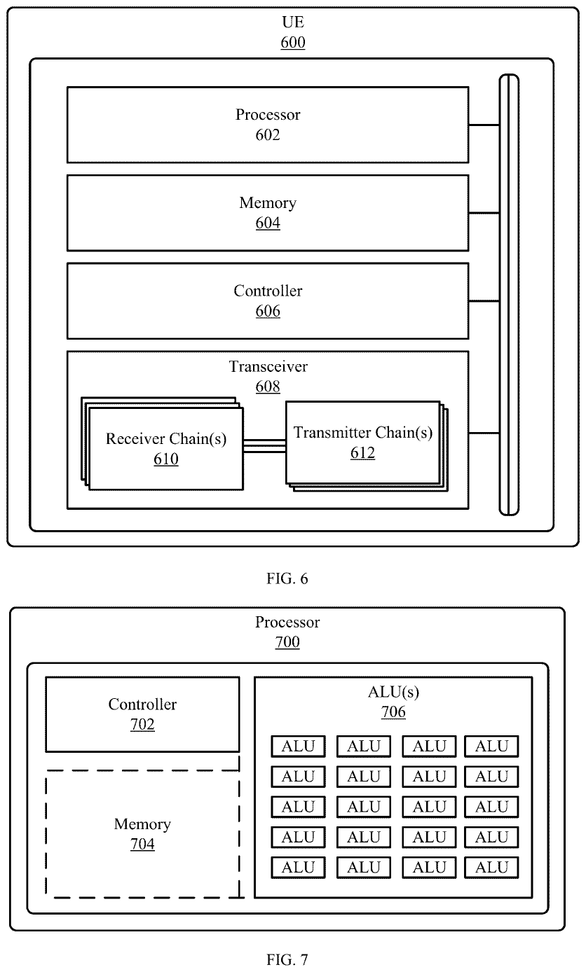

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine a subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs, and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein.

For example, the processor 700 may be configured to support means for performing the operations as described with respect to FIG. 4. For example, the processor 700 may be configured to or operable to support: a means for receiving signaling for configuring a first set of serving cells, which is co-schedulable by a DCI; a means for receiving the DCI scheduling a second set of serving cells in the first set of serving cells and indicating a TCI state different from a previously indicated TCI state; a means for generating a HARQ-ACK codebook for the DCI; a means for transmitting the HARQ-ACK codebook; and a means for applying the TCI state in response to the HARQ-ACK codebook including at least one ACK bit.

For example, the processor 700 may be configured to support means for performing the operations as described with respect to FIG. 5. For example, the processor 700 may be configured to or operable to support: a means for transmitting, to a UE, signaling for configuring a first set of serving cells, which is co-schedulable by a DCI; a means for transmitting, to the UE, the DCI scheduling a second set of serving cells in the first set of serving cells and indicating a TCI state different from a previously TCI state indicated to the UE; a means for receiving, from the UE, a HARQ-ACK codebook for the DCI; and a means for applying the TCI state in response to the HARQ-ACK codebook including at least one ACK bit.

It should be appreciated by persons skilled in the art that the components in exemplary processor 700 may be changed, for example, some of the components in exemplary processor 700 may be omitted or modified or a new component(s) may be added to exemplary processor 700, without departing from the spirit and scope of the disclosure. For example, in some embodiments, the processor 700 may not include the ALUs 706.

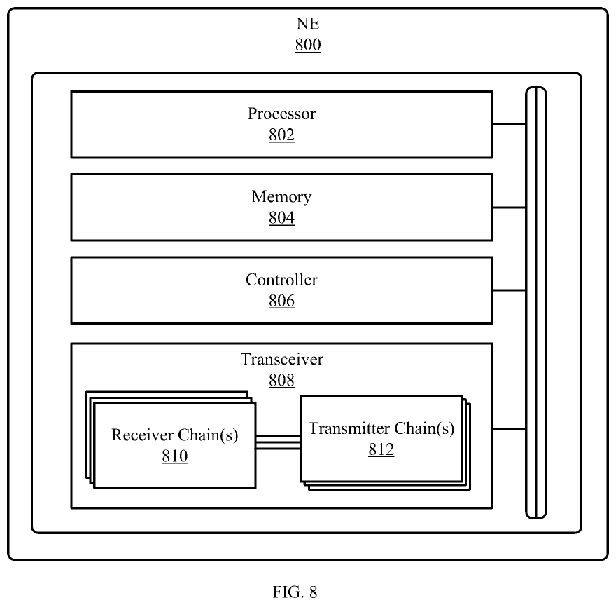

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. For example, the NE 800 may be configured to support means for performing the operations as described with respect to FIGS. 1-5.

For example, the NE 800 may be configured to support: a means for transmitting, to a UE, signaling for configuring a first set of serving cells, which is co-schedulable by a DCI; a means for transmitting, to the UE, the DCI scheduling a second set of serving cells in the first set of serving cells and indicating a TCI state different from a previously TCI state indicated to the UE; a means for receiving, from the UE, a HARQ-ACK codebook for the DCI; and a means for applying the TCI state in response to the HARQ-ACK codebook including at least one ACK bit.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, or packets) over a wireless medium. For example, the receiver chain 810 may include one or more antennas for receive the signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, or packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

It should be appreciated by persons skilled in the art that the components in exemplary NE 800 may be changed, for example, some of the components in exemplary NE 800 may be omitted or modified or a new component(s) may be added to exemplary NE 800, without departing from the spirit and scope of the disclosure. For example, in some embodiments, the NE 800 may not include the controller 806.

Those having ordinary skill in the art would understand that the operations or steps of the methods described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of the methods may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. The disclosure is not limited to the examples and designs described herein but is to be accorded with the broadest scope consistent with the principles and novel features disclosed herein. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “DCI” and “DCI format” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” or the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive a configuration for a first set of serving cells, which is co-schedulable by a downlink control information (DCI);
receive the DCI scheduling a second set of serving cells in the first set of serving cells and indicating a transmission configuration indication (TCI) state different from a previously indicated TCI state;
generate a hybrid automatic repeat request acknowledgement (HARQ-ACK) codebook for the DCI;
transmit the HARQ-ACK codebook; and
apply the TCI state in response to the HARQ-ACK codebook comprising at least one acknowledgement (ACK) bit.

2. The UE of claim 1, wherein to apply the TCI state in response to the HARQ-ACK codebook comprising at least one ACK bit, the at least one processor is configured to cause the UE to apply the TCI state in response to that all HARQ-ACK information bits excluding padding bits in the HARQ-ACK codebook are ACK bits.

3. The UE of claim 1, wherein to generate the HARQ-ACK codebook for the DCI, the at least one processor is configured to cause the UE to generate an ACK bit for indicating a reception of the DCI.

4. The UE of claim 3, wherein the ACK bit for indicating the reception of the DCI is generated in response to one of:
a number of serving cells in the second set of serving cells being greater than one and less than an allowable maximum number of serving cells co-schedulable by the DCI;
the number of serving cells in the second set of serving cells being greater than one; and
the number of serving cells in the second set of serving cells being greater than or equal to one and the DCI further indicating secondary cell (SCell) dormancy.

5. The UE of claim 3, wherein the ACK bit for indicating the reception of the DCI acts as a padding bit in the HARQ-ACK codebook.

6. The UE of claim 3, wherein the ACK bit for indicating the reception of the DCI is arranged at a predefined position in the HARQ-ACK codebook.

7. The UE of claim 1, wherein to generate the HARQ-ACK codebook for the DCI, the at least one processor is configured to cause the UE to:
generate HARQ-ACK information bits for the second set of serving cells; and
in response to a number of bits of the generated HARQ-ACK information bits being greater than one and less than a predefined number of HARQ-ACK information bits, add at least one padding bit to the generated HARQ-ACK information bits to match the predefined number, wherein the at least one padding bit comprises an ACK bit for indicating a reception of the DCI.

8. The UE of claim 1, wherein to generate the HARQ-ACK codebook for the DCI, the at least one processor is configured to cause the UE to:
generate HARQ-ACK information bits for the second set of serving cells; and
in response to a number of bits of the generated HARQ-ACK information bits being greater than one, add at least one padding bit to the generated HARQ-ACK information bits to match a predefined number of HARQ-ACK information bits; and
generate an ACK bit for indicating a reception of the DCI.

9. The UE of claim 1, wherein the DCI further indicates secondary cell (SCell) dormancy and wherein to generate the HARQ-ACK codebook for the DCI, the at least one processor is configured to cause the UE to:
generate HARQ-ACK information bits for the second set of serving cells and SCell dormancy indication; and
in response to a number of bits of the generated HARQ-ACK information bits being less than a predefined number of HARQ-ACK information bits, add at least one padding bit to the generated HARQ-ACK information bits to match the predefined number; and
generate an ACK bit for indicating a reception of the DCI.

10. The UE of claim 1, wherein to generate the HARQ-ACK codebook for the DCI, the at least one processor is configured to cause the UE to, in response to the second set of serving cells comprising a single serving cell, generate a negative ACK (NACK) bit or an ACK bit corresponding to the single serving cell.

11. The UE of claim 1, wherein the DCI further indicates secondary cell (SCell) dormancy by reinterpreting a set of fields associated with a first serving cell of a third set of serving cells in the first set of serving cells, and wherein the HARQ-ACK codebook comprises an ACK bit for the first serving cell.

12. A base station (BS) for wireless communication, comprising:
at least one memory; and
at least one processor coupled with the at least one memory and configured to cause the BS to:
transmit, to a user equipment (UE), a configuration for a first set of serving cells, which is co-schedulable by a downlink control information (DCI);
transmit, to the UE, the DCI scheduling a second set of serving cells in the first set of serving cells and indicating a transmission configuration indication (TCI) state different from a previously TCI state indicated to the UE;
receive, from the UE, a hybrid automatic repeat request acknowledgement (HARQ-ACK) codebook for the DCI; and
apply the TCI state in response to the HARQ-ACK codebook comprising at least one acknowledgement (ACK) bit.

13. The BS of claim 12, wherein to apply the TCI state in response to the HARQ-ACK codebook, the at least one processor is configured to cause the BS to apply the TCI state in response to all HARQ-ACK information bits excluding padding bits in the HARQ-ACK codebook being ACK bits.

14. The BS of claim 12, wherein the at least one ACK bit in the HARQ-ACK codebook comprises an ACK bit for indicating a reception of the DCI.

15. The BS of claim 14, wherein the HARQ-ACK codebook comprises the ACK bit for indicating the reception of the DCI in response to one of:
a number of serving cells in the second set of serving cells being greater than one and less than an allowable maximum number of serving cells co-schedulable by the DCI;
the number of serving cells in the second set of serving cells being greater than one; or
the number of serving cells in the second set of serving cells being greater than or equal to one and the DCI further indicating secondary cell (SCell) dormancy.

16. The BS of claim 14, wherein the ACK bit for indicating the reception of the DCI acts as a padding bit in the HARQ-ACK codebook.

17. The BS of claim 14, wherein the ACK bit for indicating the reception of the DCI is arranged at a predefined position in the HARQ-ACK codebook.

18. The BS of claim 12, wherein the DCI further indicates secondary cell (SCell) dormancy by reinterpreting a set of fields associated with a first serving cell of a third set of serving cells in the first set of serving cells, and wherein the HARQ-ACK codebook comprises an ACK bit for the first serving cell.

19. (canceled)

20. A method performed by a user equipment (UE), the method comprising:
receiving signaling for configuring a first set of serving cells, which is co-schedulable by a downlink control information (DCI);
receiving the DCI scheduling a second set of serving cells in the first set of serving cells and indicating a transmission configuration indication (TCI) state different from a previously indicated TCI state;
generating a hybrid automatic repeat request acknowledgement (HARQ-ACK) codebook for the DCI;
transmitting the HARQ-ACK codebook; and
applying the TCI state in response to the HARQ-ACK codebook comprising at least one acknowledgement (ACK) bit.

21. A method performed by a base station (BS), the method comprising:
transmitting, to a user equipment (UE), a configuration for a first set of serving cells, which is co-schedulable by a downlink control information (DCI);
transmitting, to the UE, the DCI scheduling a second set of serving cells in the first set of serving cells and indicating a transmission configuration indication (TCI) state different from a previously TCI state indicated to the UE;
receiving, from the UE, a hybrid automatic repeat request acknowledgement (HARQ-ACK) codebook for the DCI; and
applying the TCI state in response to the HARQ-ACK codebook comprising at least one acknowledgement (ACK) bit.
